(19) United States
(12) Patent Application Publication
(10) Pub. No.: US 2006/0052096 A1
(43) Pub. Date: Mar. 9, 2006

(54) Wireless communication systems and methods for updating locating information of mobile station using multicast

(76) Inventors: Konstantin Dolgov, Vesterby Alle 3, 2 TV (DK); Thomas Kildegaard, Smorum (DK)

Correspondence Address: MOTOROLA, INC., 1303 EAST ALGONQUIN ROAD, IL01/3RD, SCHAUMBURG, IL, 60196, US

(21) Appl. No.: 10/535,143

(22) PCT Filed: Nov. 10, 2003
(86) PCT No.: PCT/EP03/50811

§ 371 Date: May 17, 2005

(30) Foreign Application Priority Data
Nov. 20, 2002 (GB) 0227204.5

(51) Int. Cl. H04Q 7/20

(52) U.S. Cl. 455/422.1; 455/445

(57) ABSTRACT

A wireless zone-based communication system (200, 300) includes a plurality of zones (150-158) being served with short data capabilities by a plurality of short data routers (220-224). At least one zone controller (210) from a number of zone controllers transmits a multicast message (430, 440) to the plurality of short data routers (220-224). At least one short data router (220) is able to generate or update information relating to mobile communication units that are operational in the one or more zones the short data router (220) serves. Preferably, the short data router serves as a primary and/or secondary (back-up) and/or load sharing short data router. A method for improving redundancy provision in a wireless zone-based communication system (200, 300), a zone controller (210) and a short data router (220) are also described.

### FIELD OF THE INVENTION

This invention relates to wireless communication systems and methods, particularly redundancy provision in a multi-zone wireless communication system and method. The invention is applicable to, but not limited to, redundancy provision in short data routers for use in handling Internet Protocol multicast mobility updates.

### BACKGROUND OF THE INVENTION

Wireless communication systems, for example cellular telephony or private mobile radio communication systems, typically provide for radio telecommunication links to be arranged between a plurality of base transceiver stations (BTSs) and a plurality of subscriber units, often termed mobile stations (MSs).

In a wireless communication system, each BTS has associated with it a particular geographical coverage area (generally defined as a zone or a cell). Transmit power and receiver sensitivity of both the BTS and the plurality of MS served by the BTS defines the coverage area where the BTS can maintain acceptable communications with MSs operating within its serving cell. Typically, these cells combine to produce an extended coverage area, generally referred to as a ‘zone’. For very large private mobile radio systems, the system will likely be configured with multiple zones, to provide radio coverage over, say, a whole country.

One example of a zone-based wireless communication system is system designed in accordance with TErrestrial Trunked RAdio (TETRA) standards, as defined by the European Telecommunications Standards Institute (ETSI). A primary application for TETRA equipment is communication by the emergency services, as TETRA provides a dispatch and control operation. The system infrastructure in a TETRA system is generally referred to as a switching and management infrastructure (SwMI), which substantially contains all of the system elements apart from the mobile units. This includes BTSs connected to a conventional public-switched telephone network (PSTN) through base station controllers (BSCs) and mobile switching centres (MSCs).

A known configuration is to use Zone Controllers to provide inter-zone and intra-zone communications, with the zone controllers located in clusters without the need for WAN links. In such a configuration, a zone controller is generally termed a Mobile Switching Office (MSO).

It is envisaged that TETRA systems will include a concept of one or more Short Data Router(s) (SDR) per MSO. In the context of the present invention, an MSO can be considered as consisting of a number of zones. One or more SDRs located in the MSO will serve the MSs that are currently registered with the respective MSO. Hence, each SDR will serve one or more assigned zones.

In particular, each SDR maintains a mobility database that tracks the served MSs' location within the zone (s) supported by the respective SDR. The database is effectively a copy of the zone controller (ZC) mobility database. The ZC's database is constructed from the mobility information provided by all of the respective MSs within the communication system.

An identified problem in the application of SDRs within their respective MSOs is that failure of one SDR leaves all MSs in the zones that were served by the failed SDR without a Short Data service.

A first method, generally used to address reliability (failsafe) problems, is a ‘2N’ hardware redundancy solution. This solution effectively provides a second functional unit that waits in an operational standby mode until the primary unit fails. Upon failure of the primary unit, the waiting, fully functional, secondary unit is switched in-generally termed ‘hot switchover’.

The main recognised disadvantage of a ‘2N’ hardware redundancy solution is that the system is equipped with duplicate hardware modules, thereby significantly increasing the cost. When the duplication is used throughout large, multi-zone systems, the ‘2N’ solution is impractical.

However, in the context of the present invention, the primary problem is the requirement to update, on a real time basis, the MS location information in a back-up SDR. This is envisaged to be a significant problem, as only the primary SDR receives location updates from the ZC. Therefore, to implement a hot switchover in a 2N redundant system, the MS location database within the primary SDR must continually synchronize and update data with the corresponding location database in the standby (secondary) SDR.

It is known that synchronisation of such databases is a complicated and load heavy task. Hence, the database information has to be copied from the primary (active) SDR's database to the secondary SDR's database in a real-time manner. This effectively means that each and every update of the main location database has to be immediately replicated, in a reliable manner, by the primary SDR and transmitted to the backup database in the secondary SDR.

Hence, the 2N SDR (and therefore location database) solution requires a significant amount of resource and processing power. Furthermore, the above synchronisation process is a complex operation, as several SDR may track MS location information in many zones, with each primary SDR needing to manage the location database back-up operation of their respective secondary SDRs.

FIG. 1 shows a known mechanism for redundancy provision in a simplistic representation of a wireless communication system 100. The communication system includes a zone controller (ZC) 110 that is operably coupled to a SDR 122. A second SDR 124 is operably coupled to the ZC 110 and provides a back-up SDR function for the first SDR 122. In this manner, the second SDR 124 receives mobility location information from the primary SDR, whenever the primary SDR receives a mobility location information update.

A second method sometimes used to attempt to address reliability (failsafe) problems, is a ‘N+1’ load-sharing solution. This solution effectively provides a single additional functional unit. The functional requirements of the system are shared between the requisite number of hardware modules, and this additional hardware module, to provide some capacity in the functional units in the system. Upon failure of a hardware module, the traffic load supported by that hardware module is distributed amongst the remaining ‘N’ hardware modules. This solution does not require as many hardware modules to be installed, as there is no requirement for multiple back up functional units. However, it is prone to the potential problem of any further hardware module failure leaving the system unable to cope with two modules out of commission.

This solution also suffers from the problem of updating the respective mobility location databases when the methodology is applied to secondary SDRs having back-up mobility location databases.

In contrast to the 2N system, the ‘N+1’ solution will no longer require the SDRs to self-synchronise their respective databases. In a ‘N+1’ system, the ZC maintains a real-time, up-to-date knowledge of all of the SDR topology and their respective MS location information. In this regard the ZC sends a duplicate transmission to the primary SDR and its corresponding secondary SDR, with the same MS location database information. Clearly, this is far from an optimal arrangement.

However, the inventors of the present invention have recognised a further problem with the load-sharing ‘N+1’ solution when considered in the aforementioned SDR context. Namely, a ‘N+1’ solution requires more connections to the sites served by the SDRs in addition to many more links between the SDRs and the ZC to receive dedicated location database information. This results in increased connection costs and required processing power.

Notably, in scenarios where one or more SDRs is performing a primary role for a number of its associated zones/sites, as well as a secondary role for a number of other zones/sites, the dedicated download process becomes very complex. Furthermore, the dedicated download process is processor hungry and time consuming. Consequently, the integrity of the dedicated download location information decreases in its reliability.

Thus, in summary, load sharing is generally a desirable feature in large systems, to balance resource use between zones upon a unit failure. Such a load-sharing arrangement causes difficulty in the case of simultaneously updating a back-up SDR (and its mobility location database(s)) as the back-up SDR will also need to seamlessly and immediately replace the operation of the failed main SDR. This is a particularly acute problem when many SDRs are providing a back-up service to a number of other SDRs. Furthermore, in the full load-shared configuration of all SDRs connected to all sites, there is a requirement to maintain too many links between the SDRs and ZC(s) that remain idle. This leads to an inefficient and unproductive use of each SDR.

A need therefore exists for an improved redundancy mechanism, particularly to maintain integrity in mobility location information when there is a SDR failure in a multi-zone communication system, wherein the abovementioned disadvantages may be alleviated.

### STATEMENT OF INVENTION

In accordance with a first aspect of the present invention there is provided a wireless zone-based communication system that includes a plurality of zones being served with short data capabilities by a plurality of short data routers. At least one zone controller from a number of zone controllers transmits a multicast mobility update message to the plurality of short data routers, such that at least one short data router is able to generate one or more mobility databases for mobile units that are operational in the one or more zones the short data router serves. Preferably, the short data router serves as a primary and/or secondary (back-up) and/or load sharing short data router.

In accordance with a second aspect of the present invention, there is provided a method for improving redundancy provision in a wireless zone-based communication system, as claimed in claim 9.

In accordance with a third aspect of the present invention, there is provided a zone controller, as claimed in claim 12.

In accordance with a fourth aspect of the present invention, there is provided a short data router, as claimed in claim 13.

Further aspects of the invention are provided in the dependent Claims.

In summary, the inventive concepts described herein provide a mechanism to ensure that all short data routers are simultaneously provided with the same mobility update information, by multicast transmissions of, preferably, mobility location information from the one or more zone controllers. The maintenance of the mobility databases in each of the short data routers, whether primary, back up or load-shared, is therefore accurate and synchronised.

### BRIEF DESCRIPTION OF THE DRAWINGS

FIG. 1 shows a simplistic representation of a known mechanism for redundancy provision in a wireless communication system.

Exemplary embodiments of the present invention will now be described, with reference to the accompanying drawings, in which:

FIG. 2 illustrates a simplistic representation of a mechanism for redundancy provision in a wireless zone-based communication system adapted to support the various inventive concepts of the preferred embodiment of the present invention;

FIG. 3 illustrates a zone-based system architecture, adapted to implement the preferred embodiment of the present invention; and

FIG. 4 illustrates a message sequence chart of the preferred multicast mobility update message operation of the preferred embodiment of the present invention.

### DESCRIPTION OF PREFERRED EMBODIMENTS

In the context of the present invention, a multicast message is transmitted to SDRs from a plurality of zone controllers. It is within the contemplation of the invention that the multicast message, sent to the SDRs, may encompass any information required by the SDRs to provide an acceptable back-up or load-sharing function for other SDRs. However, in the preferred embodiment of the present invention, the multicast message includes mobility and/or location information relating to MSs operating within the respective zones. The message may include general information, updated information, or a complete mobility or location database.

Furthermore, it is within the contemplation of the present invention that, in general any information that changes frequently and is needed by more then one entity is a candidate for use with the inventive concepts herein described. For example, this would include any radio related parameters, such as radio status (ON/OFF) information, or any other user-radio association. Hereinafter, the term ‘multicast message’ is to be viewed as covering any or all of the above definitions.

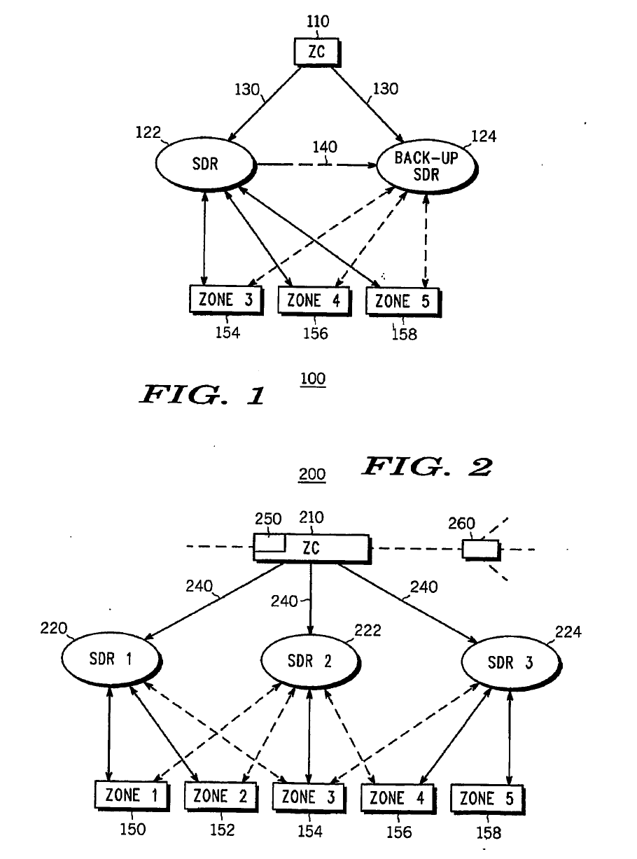

Referring first to FIG. 2, a simplistic representation of a mechanism for redundancy provision in a wireless zone-based communication system, is illustrated. For example, the system is one that supports a TErrestrial Trunked RAdio (TETRA) air-interface. The European Telecommunications Standards Institute (ETSI) has defined the TETRA air-interface. Generally, the air-interface protocol is administered from base transceiver sites (BTSs) that are geographically spaced apart—one BTS supporting a cell or, for example, sectors of a cell. A number of cells are linked to form a number of zones. Five zones 150, 152, 154, 156, 158 only are illustrated.

A zone controller 210 controls communication in, and between, zones.

A number of short data routers (SDRs) 220, 222, 224 are arranged to provide router functionality between external data hosts, such as the Internet, accessible by wireless TETRA MSs via a public switched telephone network (PSTN) or a public data network (PDN) gateway 250. Each SDR 220, 222, 224 is connected (not shown) to every other SDR. Each SDR 220, 222, 224 is a host independent application, which connects to the short data transport service (SDTS) connection management layer, as defined by the TETRA standard procedures. The SDTS provides an unreliable message relay service.

The SDR 220, 222, 224 also provides routing capabilities for MS data terminal equipment (DTE) applications through the infrastructure. The addressing capabilities offered by the SDTS allow MS-MS messaging, either directly or through a server located at the infrastructure. This effectively provides a client/server structure, which can be used to provide reliable message transportation.

It is envisaged that one SDR is able to route messages between, say one hundred sites in ten zones and between ten SDRs in ten zones. Thus, for large multi-zone/site systems, the operation of one or more SDRs can become very complex. Hence, three zones are shown in FIG. 2 for explanatory purposes only. A skilled artisan will appreciate that many other configurations and number of SDRs can be utilised to benefit from the inventive concepts hereinafter described.

In accordance with the preferred embodiment of the 5 present invention, in order to resolve the problem of mobility location database updating, a redundancy scheme using multicasting is employed. In this manner, the zone controller 210 sends out a multicast message 240 to all SDRs. The multicast message 240 includes the MS mobility or location information in the form of a database or updates or any other form for all MSs operating in the various zones. Hereinafter, the term “MS mobility information” will be used to cover the various content options of the multicast message. Thus, mobility location information in primary and/or secondary (standby) and/or load sharing SDRs is continuously updated.

FIG. 2 indicates one of many possible topologies that can benefit from the multicasting (parallel-updating) mechanism. In the configuration of FIG. 2, each of the SDRs 220, 222, 224 are arranged to back up one or more other SDRs. In this manner, following a SDR failure, the remaining SDRs will take over all (or only a part) of the SDR functionality for the zone or zones being served by the failed SDR. For example, if the second SDR 222 fails, the first and third SDR 220, 224 are arranged to provide back-up functions for zone 3—the zone primarily supported by the failed SDR 222. In this regard, the operation of the failed SDR will be shared between, or taken over by one of, the first and third SDRs 220, 224.

Advantageously, in accordance with the preferred embodiment of the present invention, the first and third SDRs 220, 224 have accurate, synchronised and updated MS mobility information, following receipt of multicast messages from the zone controller 210 (and other zone controllers 260 to all SDRs.

Every SDR 220, 222, 224 that is not dependent upon other SDRs maintains a database of mobility information of MSs in the served (and back-up) zones. In this regard, the ZC(s) 210 sends out multicast messages to specific multicast group addresses. SDRs obtain the MS mobility information by joining the respective multicast groups. In particular, the backup SDR, for example first and third SDRs 220 and 224 are configured to join the multicast groups associated with zone 3. In a similar manner, other SDRs (not shown) may be configured as back-up SDRs for the zones 1, 2, 3. Thus, each back-up SDR is able to maintain an up-to-date MS mobility (and/or location) database by joining the multicast groups that are used by the particular (main) SDR to receive the mobility information from the ZC.

It is known that in such a radio system every MS is registered with the BTS that the MS is located in. This registration information is sent to the ZC home location register (HLR)/vesting location register (VLR) database. As soon as the MS changes its location from one BTS to another BTS, this update of location is sent to the ZC.

In summary, in accordance with the preferred embodiment of the present invention, when the ZC receives a location information update from the BTS that served, or is about to serve, the MS, the ZC sends this information to the specific multicast address. The specific multicast address is pre-configured in the IP network. All SDRs (both primary and backup) who are interested in this information join this multicast group. In this manner, all the respective SDRs receive copies of location update messages sent by ZC to the multicast group.

Advantageously, by using a multicast approach to SDR mobility database management, for both primary and backup SDRs, there is no need to perform individual synchronisation of primary and back-up SDR databases. This is due to the fact that all SDRs receive the MS mobility information simultaneously from the same sources. In other words, the present invention avoids the need for the primary SDR to replicate the MS mobility information and transmit it as frequently as possible to the respective back-up SDR(s) in a reliable manner.

In a preferred embodiment of the present invention, a location query mechanism is utilised whenever the multicast message proves to be inaccurate, e.g. should a link between a ZC and an SDR fail. In this preferred embodiment, the SDR directly queries the ZCs home location register (HLR) and/or visitor location register (VLR) to obtain accurate MS mobility information. However, it should be noted that the chances of the SDRs becoming unsynchronised in this manner are very low when the primary and backup SDRs are able to be located on the same local area network (LAN).

An additional advantage of the proposed solution is that the redundancy scheme can be dynamically reconfigured amongst the SDRs, i.e. in an “on the fly” manner. Thus, an SDR can be quickly and dynamically assigned as a back up SDR, perhaps following another SDR failing and the re-distribution of SDR resources being unbalanced, to listen to the new ZC multicast messages.

Notably, the invention addresses the problems in scenarios where a dedicated download process is used. Here, the integrity of the dedicated download location information may become more unreliable. In such a scenario, this problem is resolved by use of multicast for mobility updates, using a protocol based on the multicast (UDP) that is connectionless. If there are no extra connections to maintain, then implicitly there is no extra, unproductive performance consumption of the SDR. Additionally, the ZC sends only one copy of mobility information to all SDRs.

A preferred application of the present invention is for use with Internet Protocol (IP) multicast messages. In this regard, an IP multicast capable network provides the mechanisms to replicate and deliver messages to all SDR that are joined to a specific, predefined multicast address. Nevertheless, it is within the contemplation of the invention that any other multicast messaging approach could utilise the aforementioned inventive concepts.

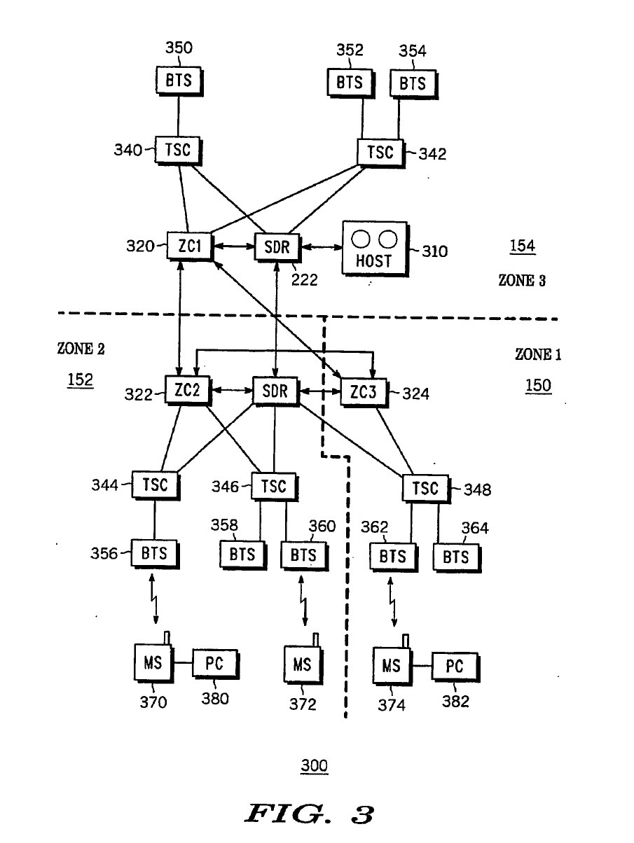

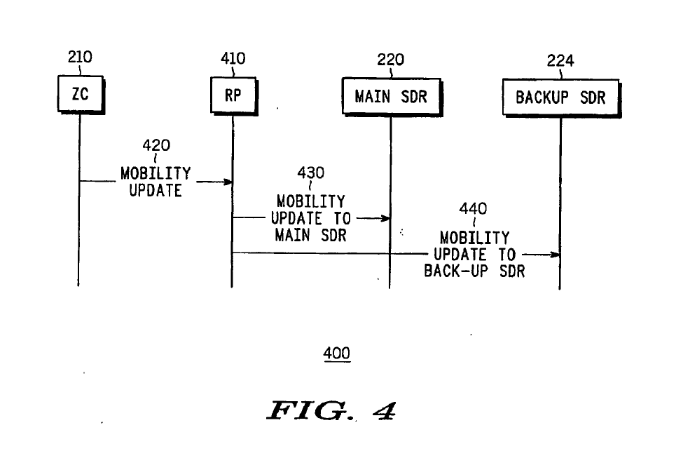

Referring now to FIG. 3, a zone-based system architecture 300 is shown, adapted to implement the preferred embodiment of the present invention. As shown, every ZC 320, 322, 324 is inter-connected to facilitate inter-zone and intra-zone calls, with one ZC supporting one zone. A ZC 320, 322, 324 is also connected to every Tetra site controllers (TSC) in a zone. Also, it is likely that a number of the ZCs 320, 322, 324 could have a PSTN gateway, to enable MSs to access external data or telephone networks.

Every SDR 220, 222 is connected to every other SDR for inter-SDR routing (although only two SDRs are shown for clarity purposes). The SDRs 220, 222 are connected to a number of TSCs in the zones they serve, for example SDR 222 in zone 3 is connected to TSCs 340, 342. Following the arrangement in FIG. 2, SDR 222 serving zone 3 is also configured to be back-up for SDR 220 with regard to zones 1 150 and zone 2 152. SDR 220 is also providing a back up for SDR 222 with respect to zone 3 154. Other SDRs serving other zones, and providing further back-ups for the three zones indicated, are not shown for clarity purposes only.

TSCs 340-348 are respectively coupled to BTSs 350-364 that provide a wireless (air-interface) link with MSs 370-376, which may be coupled to a computing terminal such as a personal computer 380, 382. In this configuration, each SDR obtain MS mobility information from all the ZCs in the zones that the SDR is serving.

This information is distributed, as described above, in a multicast message.

The multicast message is preferably generated and distributed, as shown in the message sequence chart 400 of FIG. 4. Notably, MS mobility information is delivered to SDRs in a real time and synchronised manner. Each of the ZCs, for example ZC 210, transmits a MS mobility information message to a predefined multicast address in the network. All SDRs interested in this information join the multicast group defined by this multicast address. In this manner, the IP network knows to which hosts (SDRs) it shall distribute this information. In addition, the Network also knows where the SDRs are located.

A mobility information message travelling though the network towards the SDR would likely pass through a number of routers. It is envisaged that some of these routers may be one or more replication points 310. A router, functioning as a replication point 310, receives the MS mobility information message from the ZC and replicates the message a required number of times. The number of replications is dependent upon the number of SDRs that are associated with/joined to the group identified in the MS mobility information message. The replication point 310 then transmits 430 the multicast message to the primary SDR 220. The replication point 310 also transmits 440 the multicast message to all other back-up SDRs, for example SDR 224. These transmissions are performed simultaneously, i.e. in a multicast manner, so that the integrity of the mobility data between the SDRs is maintained.

It is within the contemplation of the invention, as will be appreciated by a person skilled in the art, that many other architecture configurations could benefit from the multicast messages described above. For example, a skilled artisan would appreciate that the multicast-messaging concept in a SDR redundancy scenario is applicable to any of a number of SDR-ZC architectures. Furthermore, although, the preferred embodiment of the present invention has been described with respect to IP multicasting in a TETRA system, it is envisaged that it is equally applicable to mobility messages in a cellular communication system, or any other mobile radio system.

Indeed, it is envisaged that the inventive concepts herein described can be applied to any system having a need for redundancy, where information related to the efficient operation of the system changes frequently. For example, in a case where a redundant ZC concept is applied, then information updates for the BTS to a primary ZC and a backup ZC can be effected utilising the aforementioned inventive concepts.

Furthermore, the inventive concepts are applicable to a system that uses a switching matrix, such as a telephone exchange, where a redundant Management unit controls the switch. In this scenario, the information relating to established or released connections has to be relayed to the Management unit. The inventive concepts described above can therefore be used to provide distribution of this information from switching matrix towards both a main Management unit and any redundant Management units.

It will be understood that the short data router redundancy mechanism for MS mobility tracking, as described above in accordance with an embodiment of the invention, provides at least the following advantages:

(i) The mechanism provides all SDRs simultaneously with the same MS mobility information, due to regular multicast message transmissions from the zone controller(s).

(ii) The maintenance of the MS mobility location information/databases in each of the SDRs is therefore accurate and synchronised.

(iii) There is no need to provide further messages between primary and secondary (back-up) SDRs, to ensure that the back-up SDR contains the same MS mobility information as the primary SDR.

(iv) Every SDR is configured to manage their own MS mobility location databases, and is therefore not reliant upon MS mobility information being regularly provided from other SDRs.

(v) The SDR redundancy scheme can be dynamically reconfigured amongst the SDRs, for example when one or more SDR failures leaves the remaining SDR functionality across the system unbalanced.

(vi) As multicast based distribution of information is connectionless, there is a benefit in providing a low number of connections to the SDR. In this regard, a SDR does not have to maintain a connection to every zone controller from where it receives mobility information.

(vii) In a dedicated download process, the integrity of the dedicated download location information is maintained.

Whilst specific, and preferred, implementations of the present invention are described above, it is clear that one skilled in the art could readily apply variations and modifications of such inventive concepts.

Thus, an improved mechanism for providing redundancy to short data routers, in particular tracking MS mobility data across a number of zones has been described, wherein the aforementioned disadvantages associated with prior art mechanisms have been substantially alleviated.

1. A wireless zone-based communication system comprising a plurality of zones being served with short data capabilities by a plurality of short data routers, wherein the plurality of short data routers are operably coupled to a plurality of zone controllers, the wireless zone-based communication system being characterised by:
at least one zone controller of said plurality of zone controllers being operable to transmit a multicast message to a plurality of said short data routers such that at least one short data router of the plurality of said short data routers is operable to generate or update information relating to mobile communication units that are operational in the at least one zones that the short data router serves.

2. The wireless zone-based communication system according to claim 1, wherein the plurality of said short data routers are operable to generate or update mobility information relating to said mobile communication units.

3. The wireless zone-based communication system according to claim 1, wherein the plurality of said short data routers are operable to generate or update information relating to said mobile communication units that are operational in the at least one zone that the plurality of said short data routers serve as at least one of primary, secondary (standby) and load sharing short data routers.

4. The wireless zone-based communication system according to claim 1, wherein the at least one zone controller is operable to transmit a multicast message to a multicast group address identifying a group joined by said at least one short data router.

5. The wireless zone-based communication system according to claim 1, wherein the at least one short data router is operable to utilise a location query mechanism to minimise inaccuracies in the multicast message.

6. The wireless zone-based communication system according to claim 5, wherein the location query mechanism includes said at least one short data router being operable to query directly at least one of a zone controller's home location register and a visitor location register to obtain mobile unit mobility information when inaccurate mobility information has been received in the multicast message.

7. The wireless zone-based communication system according to claim 1, wherein said multicast message comprises an Internet Protocol (IP) mobility message to maintain synchronised IP address records of mobile communication units operating in the wireless zone-based communication system.

8. The wireless zone-based communication system according to claim 1, wherein said communication system is a trunked radio system.

9. The wireless zone-based communication system according to claim 8, wherein said communication system is operable in accordance with TETRA standard procedures.

10. A method for improving redundancy provision in a wireless zone-based communication system comprising a plurality of zones being served with short data capabilities by a plurality of short data routers, the method being characterised by the steps of:
transmitting a multicast message from a zone controller to a plurality of short data routers;
receiving said multicast message at one of said plurality of short data routers; and
generating, by said short data router, at least one mobility database for mobile units that are operational in the one or more zones served by said short data router.

11. The method according to claim 10, wherein the step of generating one or more mobility databases is performed by said short data router serving as at least one of a primary, a secondary (standby) and a load sharing short data router.

12. The method for improving redundancy provision in a wireless zone-based communication system according to claim 10, wherein the step of transmitting includes transmitting a multicast message to a multicast group address identifying a group joined by said at least one short data router.

13. A zone controller adapted to transmit a multicast message to a plurality of said short data routers in a communication system according to claim 1.

14. A short data router adapted to receive a multicast message from a zone controller in a communication system according to claim 1.
